(19) United States
(12) Patent Application Publication
(10) Pub. No.: US 2016/0356300 A1
(43) Pub. Date: Dec. 8, 2016

(54) Decorative wingnut for vehicle air cleaner

(71) Applicant: Larry Garbison, Mount Pleasant, TX (US)

(72) Inventor: Larry Garbison, Mount Pleasant, TX (US)

(21) Appl. No.: 15/172,838

(22) Filed: Jun. 3, 2016

Related U.S. Application Data
(60) Provisional application No. 62/171,275, filed on Jun. 5, 2015.

(51) Int. Cl. F16B 37/16

(52) U.S. Cl. CPC F16B 37/16

(57) ABSTRACT

A decorative wingnut for a vehicle air cleaner. The wingnut provides a 1/64 scale model of the vehicle itself as the turning handle. At the center of the bottom surface of the handle, a socket is provided with female threads which may be used on the standard air cleaner stud size of 1/4″×20 threads per inch. The wingnut provides a decorative element for restored and customized antique vehicles.

### CROSS-REFERENCE TO RELATED APPLICATIONS

This application claims the benefit of U.S. Provisional Application No. 62/171,275, filed Jun. 5, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to custom vehicle accessories and in particular to a decorative wingnut for a vehicle air cleaner. When restoring an antique vehicle, auto enthusiasts frequently remove the hood and detail the engine compartment. With chrome-plated exhaust manifolds and other decorative touches, it becomes a beautiful shrine to the Detroit ideal. The wingnut on top of the air cleaner generally becomes a somewhat dull and boring vestige of what the engine compartment used to look like. A decorative wingnut for a vehicle air cleaner, providing a 1/64 scale model of the vehicle itself as the turning handle, would resolve this problem.

### SUMMARY OF THE INVENTION

Accordingly, the invention is directed to a decorative wingnut for a vehicle air cleaner. The wingnut provides a 1/64 scale model of the vehicle itself as the turning handle. At the center of the bottom surface of the handle, a socket is provided with female threads which may be used on the standard air cleaner stud size of 1/4″×20 threads per inch. The wingnut provides a decorative element for restored and customized antique vehicles.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a side view of the first exemplary embodiment, displaying the handle, and the socket.

FIG. 2 is a bottom view of the first exemplary embodiment, displaying the handle, and the socket.

FIG. 3 is a front view of the first exemplary embodiment, displaying the handle, and the socket.

FIG. 4 is a side cross section view of the first exemplary embodiment, displaying the handle and the embedded portion of the socket.

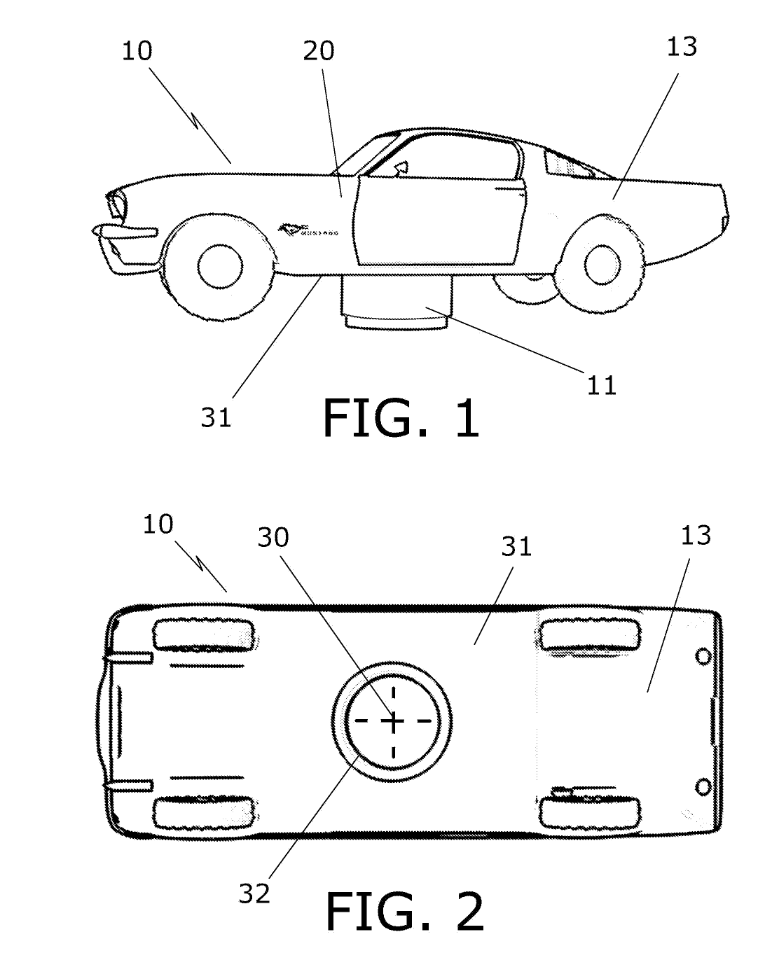

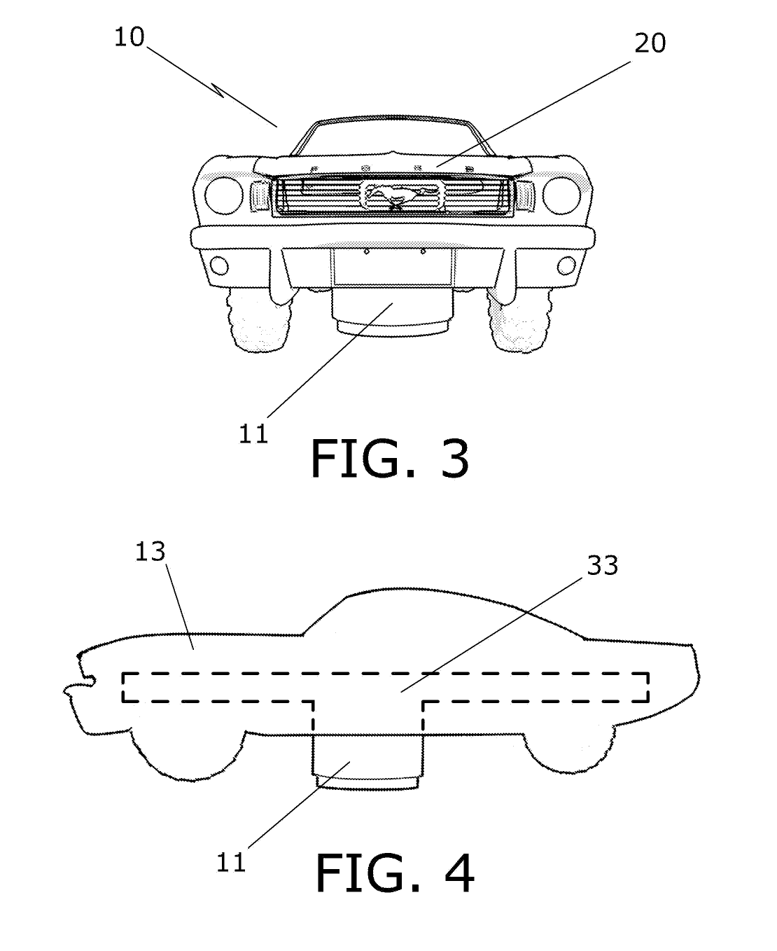

### DETAILED DESCRIPTION OF THE INVENTION

Referring now to the invention in more detail, the invention is directed to a decorative wingnut for a vehicle air cleaner 10.

The first exemplary embodiment is comprised of a handle 13 and a socket 11. The handle 13 provides a decorative element comprising a 1/64 scale model of the vehicle 20. The handle 13 is preferably hand-painted in significant detail, to closely simulate the appearance of the vehicle. At the center 30 of the bottom surface 31 of the handle 13, a socket 11 is provided with female threads 32 which may be used on the standard air cleaner stud size of 1/4″×20 threads per inch. An upper end 33 of the socket 11 extends within the handle 13 and is embedded to support the socket 11 when being turned.

The wingnut provides a decorative element 20 for restored and customized antique vehicles. Stock wingnuts are preferably provided in a broad range of models, representing the vehicle makes and models which are most popular among vehicle restoration enthusiasts, such as the 1957 Chevrolet Corvette, the 1963 Shelby Cobra, and the 1967 Chevrolet Camaro. Preferably, wingnuts may also be custom cast and hand painted to match vehicle photographs, sent to the manufacturer by owners when ordering the wingnut. An alternate embodiment, which is entirely chrome-plated rather than hand-painted, is contemplated.

To use the first exemplary embodiment, the user may secure the air cleaner lid to the air cleaner by affixing the wingnut to the stud, inserting the stud into the socket 11, and turning the handle 10 clockwise.

The handle 10 and the socket 11 are preferably manufactured from a rigid, durable material which provides substantial structural strength such as stainless steel, brass, or aluminum alloy.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A decorative wingnut for vehicle air cleaner, comprising:
a. a handle having a bottom surface;
b. a socket;
c. an upper end of said socket being embedded within the handle;
d. said handle including a decorative element which is shaped to resemble a vehicle;
e. a lower end of said socket providing female threads which are sized and configured to attach to an air cleaner stud;
f. said handle and said decorative element being constructed of a rigid durable material such that the handle and decorative element can be used to turn the socket and attach the decorative wingnut to the air cleaner stud.

2. The decorative wingnut for vehicle air cleaner of claim 1, wherein said air cleaner stud is a quarter inch stud with twenty threads per inch.

3. The decorative wingnut for vehicle air cleaner of claim 1, wherein said socket is centered on the bottom surface of the handle.

4. The decorative wingnut for vehicle air cleaner of claim 1, wherein said decorative element of a vehicle is a 1/64 scale of an actual vehicle.

5. The decorative wingnut for vehicle air cleaner of claim 4, wherein said decorative element is hand painted to match the actual vehicle.

6. The decorative wingnut for vehicle air cleaner of claim 1, wherein said decorative element resembling a vehicle resembles a 1957 Chevrolet Corvette.

7. The decorative wingnut for vehicle air cleaner of claim 1, wherein said decorative element resembling a vehicle resembles a 1963 Shelby Cobra.

8. The decorative wingnut for vehicle air cleaner of claim 1, wherein said decorative element resembling a vehicle resembles a 1967 Chevrolet Camaro.

9. The decorative wingnut for vehicle air cleaners of claim 1, wherein said decorative element resembling a vehicle is custom cast to match a vehicle from a photograph.

10. The decorative wingnut for vehicle air cleaners of claim 1, wherein said decorative element resembling a vehicle is chrome plated.
